(19) United States
(12) Patent Application Publication
(10) Pub. No.: US 2006/0200912 A1
(43) Pub. Date: Sep. 14, 2006

(54) Multipurpose hand-held tool implements

(75) Inventors: Trevor Jackson, Kirtland, OH (US); Patrick Coyne, Shaker Heights, OH (US)

Correspondence Address: CALFEE HALTER & GRISWOLD, LLP, 800 SUPERIOR AVENUE, SUITE 1400, CLEVELAND, OH, 44114, US

(73) Assignee: Emerald Innovations LLC, Butler, PA (US)

(21) Appl. No.: 11/078,652

(22) Filed: Mar. 11, 2005

(51) Int. Cl. B25F 1/00; B26B 11/00

(52) U.S. Cl. 7/110; 7/158; 15/105

(57) ABSTRACT

Tool implements are provided for use in manipulating of target substrates and materials, such as soil, plant or vegetable matter, and other materials. The tools include a body portion, a retaining strap and an aperture formed therebetween. All or a portion of one or more fingers of a human hand may be inserted through the aperture. When the user manipulates the tool implement, the retaining strap assists in retaining the users hand in close contact with the body member. The tool implements provide reinforcement and stability to the user's hand. The tool implements also provide one or more of a variety of tools that extend from the user's fingertips for manipulating target substrates. The tool implements also shield all or a portion of the user's hand from direct contact with the target substrates and materials, and in some embodiments, further protect the user's hand from being soiled.

### TECHNICAL FIELD

The present invention relates generally to multipurpose hand-held tool implements useful for a variety of tasks, including scraping, digging, and scooping target materials and substrates. More particularly, the invention relates to various embodiments of tool implements that are shaped to conform to the shape of all or a portion of a user's hand, thereby facilitating manipulation of the tool implement in the performance of tasks that are directed by the motion of the user's hand.

### SUMMARY OF THE INVENTION

Multipurpose hand-held tool implements are provided. The tool implements comprise a body member and a retaining strap. Body members according to the instant invention comprise a top face for contact with at least a portion of a human hand, and a bottom face for contact with a target material or substrate. Body members also comprise first and second side edges and hand engagement and tool ends that define the body member-periphery. The lengths of body members according to the instant invention are defined by the distance between the hand engagement end and the tool end, and are sufficient to accommodate contact with at least a portion of one or more fingers of a human hand. Body members have a width that is defined by the distance between the first and second side edges. Retaining straps according to the instant invention are engageable with a body member. When engaged with a body member, a retaining strap traverses the top face of the body member to form an aperture.

In some embodiments, tool implements of the instant invention comprise a glove member. Glove members encase all or a portion of the users hand. In some embodiments, the glove member is separate from the body member and the retaining strap. According to such embodiments, the glove member is insertable through the aperture formed by an engaged body member and retaining strap. In other embodiments, the glove member is either attached to or integrated with either the body member or the retaining strap, or both. According to such embodiments, the glove member is typically oriented such that all or a portion of the user's hand is encased within the glove member upon insertion of all or a portion of one or more fingers of the user's hand through the aperture formed by an engaged body member and retaining strap.

The tool implements of the instant invention are used for manipulation of target substrates and materials by a user. All or a portion of one or more fingers of a human hand is inserted through the aperture formed by an engaged body member and a retaining strap such that the volar surface (the palm side of the hand) of the one or more fingers is in contact with the top face of the body member, and the dorsal surface (the top side of the hand) of the one or more fingers is in contact with the retaining strap. When the user manipulates the tool implement, the retaining strap assists in retaining the users hand in close contact with the body member.

The tool implements provide reinforcement and stability to the user's hand. The tool implements also provide one or more of a variety of tools that extend from the user's fingertips for manipulating target substrates. The tool implements also shield all or a portion of the user's hand from direct contact with the target substrates and materials, and in some embodiments, further protect the user's hand from being soiled.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention, and together with the description, serve to explain the principles of the invention.

### BRIEF DESCRIPTION OF THE DRAWINGS

FIG. 1 shows a plan view of an embodiment of a multipurpose hand-held tool implement according to the instant invention, showing a glove implement insertable into the engaged body member and retaining strap;

FIG. 2 shows various embodiments of multipurpose hand-held tool implements according to the instant invention; panel (a) (1) and (a) (2) show different perspective views of the implement shown in FIG. 1; panel (b) shows an implement with a body member having a curvature along both the width and length dimensions, wherein the tool end is wider than the hand engagement end and the width broadens continuously, the tool end having a non-beveled straight edge, with side edges having a fixed height that abruptly taper to a nil height before the tool end; (c) shows a body member that is substantially flat along both the width and length dimensions, wherein the tool end is narrower than the hand engagement end and the width tapers discontinuously, the tool end having a non-beveled straight edge with teeth, with side edges having a nil height, and the central portion of the front face having roughened surface texture; (d) shows a body member having an overall shape as depicted in FIG. 1 but having a bowl-shaped tool end and wherein the bowl is formed on the front face of the body member, and to which body member and terminates before the bowl-shaped tool end is attached a retaining strap having a length that is approximately equal to the length of the body member;

FIG. 3 shows perspective view of an embodiment of a multipurpose hand-held tool implement according to the instant invention, donned by a user;

FIG. 4 shows views of various embodiments of retaining straps of multipurpose hand-held tool implements according to the instant invention; panel (a) shows a narrow strap; panel (b) shows a long strap;

FIG. 5 shows a front view of an embodiment of a multipurpose hand-held tool implement according to the instant invention;

FIG. 6 is a side view of an embodiment of a multipurpose hand-held tool implement according to the instant invention;

FIG. 7 panel (a) is a back view and panel (b) is a top view of an embodiment of a multipurpose hand-held tool implement according to the instant invention; and

FIG. 8 is end view an embodiment of a multipurpose hand-held tool implement according to the instant invention.

### DETAILED DESCRIPTION

Multipurpose hand-held tool implements and methods for using the same are provided. The tool implements are useful for a variety of tasks such as cutting, digging, scraping, scooping and spreading. The tool implements are useful for scraping the flesh from fruits and vegetables, such as pumpkins and similar vegetables and replicas thereof. The multipurpose hand-held tool implements are also useful for scooping, digging, spreading, or otherwise manipulating earth, clay, soil, dirt, vermiculite, humus, and other like materials in connection with lawn and gardening activities. The multipurpose hand-held tool implements are also useful for scooping, digging, scraping, and spreading attendant to performance of cleaning tasks, crafts, baking and cooking, light construction and remodeling, and other like activities.

The tool implements substantially conform in general shape to all or a portion of the hand of a human user, and thereby permit the user to guide and direct the tool following the natural motion of the user's hand. The tool implements provide reinforcement and stability to the user's hand to improve leverage in the performance of tasks. The tool implements also provide one or more of a variety of tools that extend from the user's fingertips or extend along the edges of the implement for manipulating target substrates. The tool implements also shield all or a portion of the user's hand from direct contact with the target substrates and materials, and in some embodiments, further protect the user's hand from being soiled by such substrates and materials.

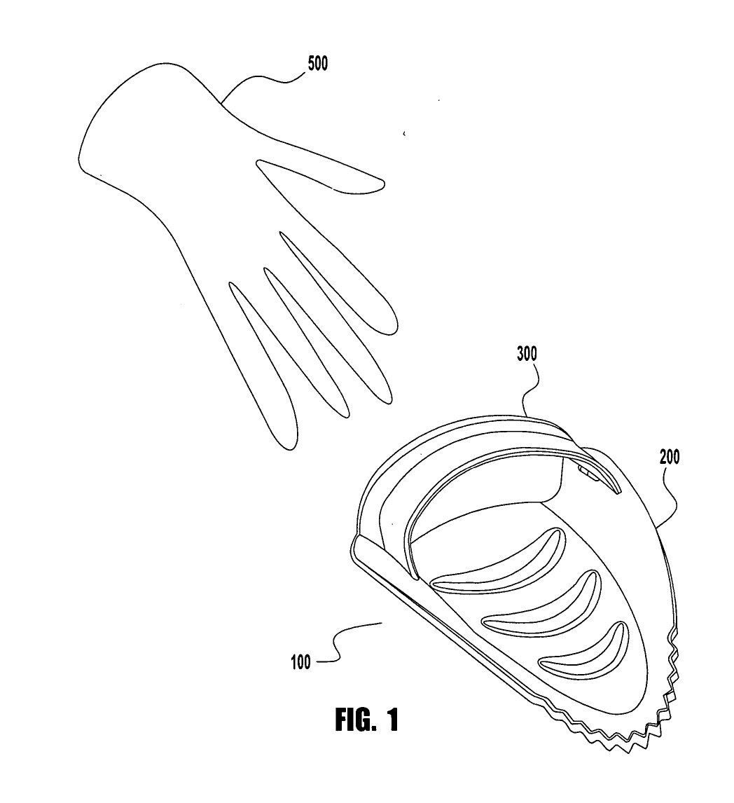

The multipurpose hand-held tool implements of the instant invention comprise a body member, a retaining strap, and in some embodiments, a glove member. FIG. 1 shows one embodiment of a multipurpose hand-held tool implement 100, comprising a body member 200 engaged with a retaining strap 300, and a glove member 500. According to the depicted embodiment, the glove member 500 is insertable through an aperture 400 that is formed when a body member 200 is engaged with a retaining strap 300.

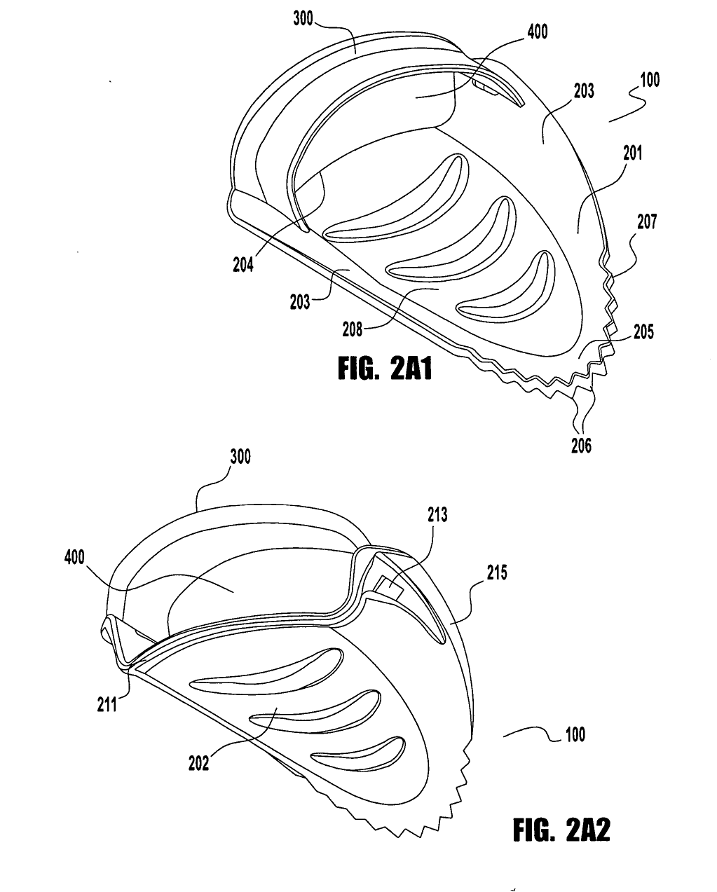

Referring now to FIG. 2, body members 200 are shown in a variety of embodiments in panels (a) through (d). Generically, a body member 200 comprises a top face 201 and a bottom face 202; first and second side edges 203; a hand engagement end 204; and a tool end 205. A body member 200 has a length L that is the distance between, and is bounded by, the hand engagement end 204 and the tool end 205, and a width W that is the distance between, and is bounded by, the first and second side edges 203

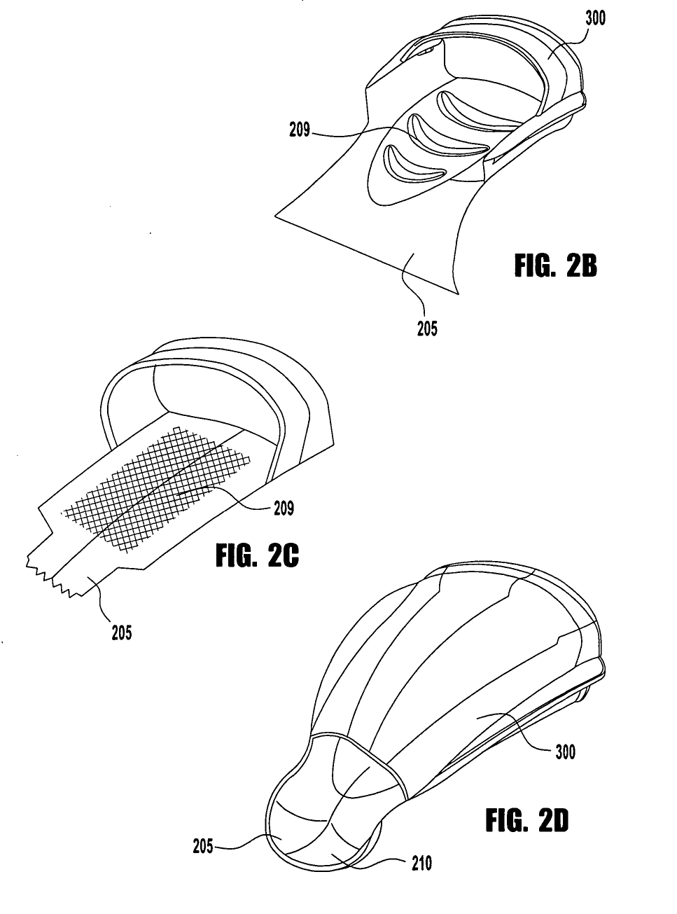

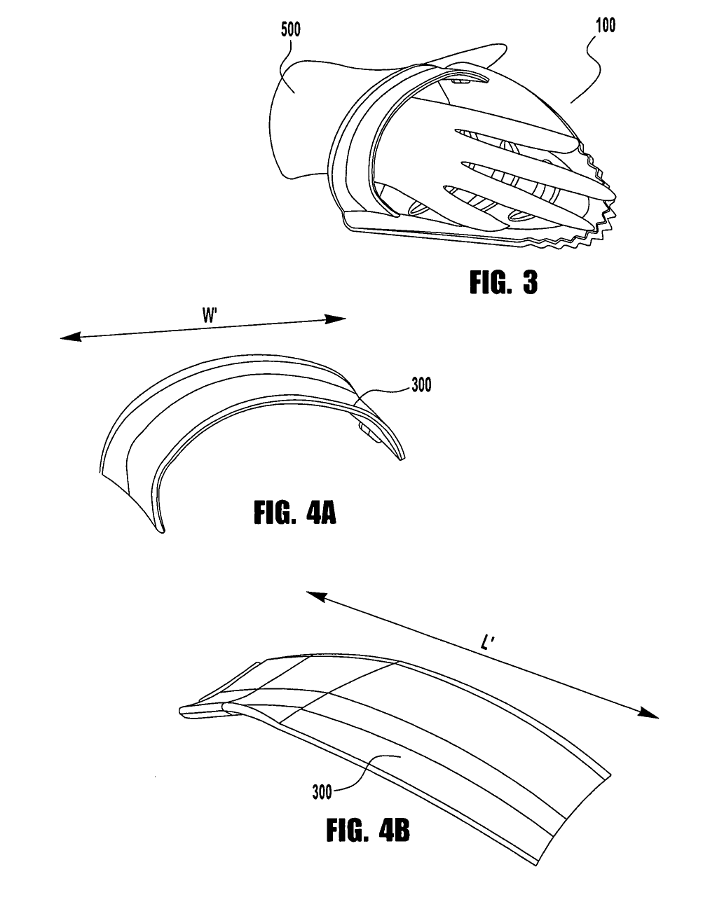

The length L is sufficient to accommodate contact between the top face 201 of the body member 200 and at least a portion of one or more fingers of an adult human hand. In other embodiments, the length L is sufficient to accommodate contact between the top face 201 of the body member 200 and at least a portion of one or more fingers of a juvenile human hand. More particularly, in some embodiments, the length L is sufficient to accommodate contact between the top face 201 of the body member 200 and at least a portion of, but nor more than, the phalange segments of one or more fingers of a human hand. According to such embodiments, when the tool implement 100 is donned by a user, as depicted in FIG. 3, the body member 200 is positioned relative to the user's hand such that the hand engagement end 204 is aligned approximately with the large joint located between the proximal phalange and the metacarpal bones of at least one finger of the user, and the tip of at least one finger of the user extends to approximately reach the tool end 205 of the body member 200.

In other embodiments, the length L is sufficient to accommodate contact between the top face 201 of the body member 200 and the phalange and metacarpal segments of one or more fingers of a human hand. According to such embodiments, when the tool implement 100 is donned by a user, as depicted in FIG. 3, the body member 200 is positioned relative to the user's hand such that the hand engagement end 204 is aligned approximately in the center of the user's palm, at a position near the large joint located between the metacarpal and carpal bones of the user's hand. Further according to such embodiments, the tip of at least one finger of the user extends along the length L to a point that is not beyond the tool end 205 of the body member 200. Even more particularly, in some embodiments, the length L is from 0.5 inches to 5 inches, wherein the length is 0.5, 0.6, 0.7, 0.8, 0.9, 1.0, 1.1, 1.2 1.3, 1.4, 1.5, 1.6, 1.7, 1.8, 1.9, 2.0, 2.1, 2.2 2.3, 2.4, 2.5, 2.6, 2.7, 2.8, 2.9, 3.0, 3.1, 3.2 3.3, 3.4, 3.5, 3.6, 3.7, 3.8, 3.9, 4.0, 4.1, 4.2 4.3, 4.4, 4.5, 4.6, 4.7, 4.8, 4.9, or 5.0 inches or more. In some particular embodiments, the length L is from 1 inches to 4.5 inches, or from 2 inches to 4 inches, or is 3.5 inches.

Referring to FIG. 2(a), the body member 200 is substantially planar and comprises a central portion 208 located between the first and second side edges 203 and the hand engagement end 204 and tool end 205. In some embodiments, as depicted in FIGS. 2(a), (b) and (d), for example, the body member 200 has a curvature, such that when the body member 200 is resting on its bottom face 202 on a flat surface, the hand engagement end 204 and the tool end 205 are in contact with the flat surface, and at least a portion of the central portion 208 is not in contact with the flat surface. According to the depicted embodiment, the curvature of the body member 200 is along the length L and along the width W. Of course, in other embodiments, the curvature may be along only one of the length L or the width W, and the radius of curvature may vary with respect to either or both length L and width W dimensions. In other embodiments, as depicted in FIG. 2(c), the body member 200 is substantially flat, such that when the body member 200 is resting on its bottom face 202 on a flat surface, the hand engagement end 204 and the tool end 205 and substantially all of the central portion 208 are contact with the flat surface.

In some embodiments, the body member 200 of a hand-held tool implement 100 comprises a gripping means 209. Referring to FIG. 2(a), such gripping means 209 comprises one or more ridges, baffles, bumps, pocks, grooves, or like structural features, or combinations thereof. In yet other embodiments, the gripping means 209 comprises surface texture that increases friction between the body member and the one or more fingers of a human hand in contact therewith. Surface texture may be in the form of hatches, ridges, grooves, on the surface of the body member 200, such texture being rendered on the body member 200 by one or a combination of etching, embossing, coating, layering, affixing or adhering. An example of textural gripping means is shown in FIG. 2(c), wherein the central portion 208 of the front face 201 has a roughened texture in the form of crosshatch etching. Of course, in yet other embodiments of the hand-held tool implement 100, the gripping means 209 may be located on other portions of the tool implement 100 surface, such as on all or a portion of the front face 201, the back face 202, the first and second edges 203, or combinations of these. Further, combinations of various gripping means may be present on various embodiments of the hand-held tool implement 100.

In some embodiments, the body member 200 of a hand-held tool implement 100 comprises a texture rendering means (not shown). Such texture rendering means comprises: one or more ridges, baffles, bumps, pocks, grooves, or like structural features, surface texture in the form of hatches, ridges, grooves rendered on the body member 200 by one or a combination of etching, embossing, coating, layering, affixing or adhering, and combinations thereof. Texture rendering means may be on are on all or a portion of the back face 202 of the body member 200, including on all or a portion of the central portion 208 of the back face 202, or along one or more of the tool edge 205 and the first and second side edges 203, or combinations of these. Texture rendering means are useful for rendering texture on the material or substrate being manipulated by the user with the hand-held tool implement 100.

In some embodiments, the back face 202 of the body member 200 of a hand-held tool implement 100 comprises shape or structure such as bowl or scoop shape, or channels (not shown). These structures are useful for containing or directing the movement of target substrate or material being manipulated by the user with the hand-held tool implement 100.

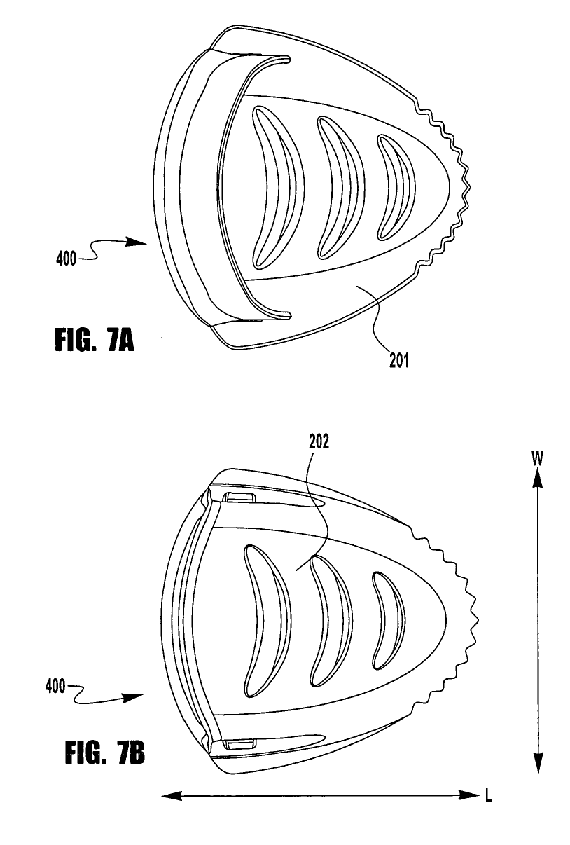

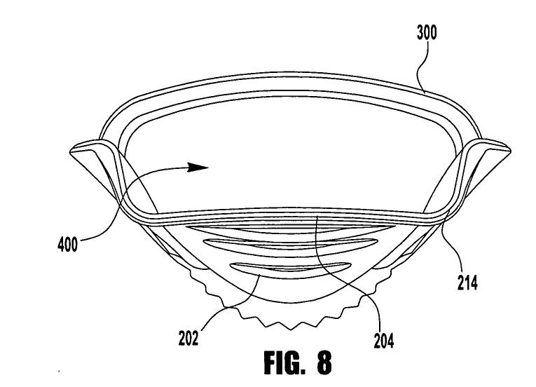

The body member 200 of a hand-held tool implement 100 comprises first and second side edges 203, the distance between which define the width W of the body member 200 along its length L. In some embodiments, as depicted in Referring to FIG. 2(c), the first and second side edges 203 have a low profile. In other embodiments, representative examples of which are depicted in FIG. 2(a), FIG. 2(b) and FIG. 6, either one or both of the first and second side edges 203 have a height H that extends above the top face 201 of the body member 200 and are arranged in an orientation that is oblique, or at an angle, relative to the top face 201 of the body member 200.

In the various embodiments, the height H of one or both of the first and second side edges 203 may vary between a minimal height that is low profile (as depicted in FIG. 2(c)), and does not extend above the top face 201 of the body member 20, and a height H that does extend above the top face 201 of the body member 20 (as depicted, for example, in FIG. 2(a)). Generally, the height H of one or both of the first and second side edges 203 relative to the top face 201 of the body member 200 can vary from between 0 and 2.5 inches or more, wherein the length is 0, 0.1, 0.2, 0.3, 0.4, 0.5, 0.6, 0.7, 0.8, 0.9, 1.0, 1.1, 1.2 1.3, 1.4, 1.5, 1.6, 1.7, 1.8, 1.9, 2.0, 2.1, 2.2 2.3, 2.4, and 2.5 inches or more.

According to some embodiments, the height H of one or both of the first and second side edges 203 decreases along the length L of the body member 200 from a maximum height at the hand engagement end 204 to a minimum height at or before the tool end 205. According to some such embodiments, the height of one or both of the first and second side edges 203 decreases to a substantially nil height at a point before the tool end 205 of the body member 200.

In yet other embodiments, the height of the first and second side edges 203 decreases to a substantially nil height at a point near or at the tool end 205 of the body member 200. And in yet other embodiments, the eight H of one or both of the first and second side edges 203 is continuous along the length L of the body member.

The junction between the termini of one or both of the first and second side edges 203 and the hand engagement end 204 and the tool end 205 may be formed by a continuous curve, or a right angle, or combinations thereof in the same body member 200. For example, referring to FIG. 8, the junction between the hand engagement end 204 and each of the first and second side edges 203 is formed by angles of approximately 90 degrees, wherein the first and second side edges 203 and the face of the body member are on different, and nearly perpendicular planes, and the first and second side edges 203 and the hand engagement end 204 share a continuous, slightly rounded terminal edge 214. Referring to FIG. 6, the junction between the tool end 205 and each of the first and second side edges 203 is formed by a gradual decline of the height H of each of the first and second side edges 203 and transition of same into the toothed portion 206 of the tool end 205. Referring to FIG. 2(c), the first and second side edges 203 are substantially on the same plane as the front face 201 of the body member, and are continuous with the tool end 205 and the hand engagement end 204. In some embodiments, the angle between the first and second side edges 203 gradually decreases from the hand engagement end 204 to the tool end 205. Of course it will be appreciated that the angles between the first and second side edges 203 and the front face 201 of the body member 200 may vary from between 0 and 360 degrees, more particularly between 45 and 90 degrees, and between 90 and 180 degrees, and between 180 degrees and 270 degrees, and between 270 degrees and 330 degrees.

In some embodiments, one or both of the first and second side edges 203 have teeth or bevels or combinations thereof disposed along the periphery 215 to cooperate with or augment the actions of the tool end 205 of such tool implements 100. As depicted in FIG. 6, the tool implement 100 comprises sloping and angled first and second side edges 203 that comprise an edge suitable for scraping. Additional detail regarding the edge features that can be employed with one or both of the first and second side edges 203 is provided herein in relation to the description of tool end embodiments.

As shown in FIG. 2(a), a body member 200 comprises a hand engagement end 204, which in some embodiments forms a portion of the aperture 400 through which at least a portion of one or more fingers of an adult or a juvenile human hand is inserted when the user dons a hand-held tool implement. The hand engagement end 204 is flat or curved and comprises in some embodiments a lipped or rounded edge 211.

Referring again to FIG. 2(a), the width W of the body member 200 is sufficient to accommodate contact between the top face 201 of the body member 200 and at least a portion of one or more fingers of an adult or a juvenile human hand, whereby the contacted portions of the one or more fingers is positioned on the top face 201 between the first and second side edges 203, with the distal portions of the one or more fingers nearer the tool end 205 and the proximal portions of the one or more fingers nearer the hand engagement end 204. In some embodiments, the width W is sufficient to accommodate contact fewer than four fingers of a user's hand. In other embodiments, the width W is sufficient to accommodate four fingers of a user's hand, such that all or a portion of all four fingers are in contact with the top face 201 of the body member 200, as depicted in FIG. 3. More particularly, in some embodiments, the width W is from 0.5 inches to 15 inches, wherein the length is 0.5, 0.6, 0.7, 0.8, 0.9, 1.0, 1.1, 1.2 1.3, 1.4, 1.5, 1.6, 1.7, 1.8, 1.9, 2.0, 2.1, 2.2 2.3, 2.4, 2.5, 2.6, 2.7, 2.8, 2.9, 3.0, 3.1, 3.2 3.3, 3.4, 3.5, 3.6, 3.7, 3.8, 3.9, 4.0, 4.1, 4.2 4.3, 4.4, 4.5, 4.6, 4.7, 4.8, 4.9, and 5.0 inches, 6, 7, 8, 9, 10, 11, 12, 13, 14, 15 inches or more, and increments thereof. In some particular embodiments, the width W is from 0.5 inches to 4.5 inches, or from 1.5 inches to 3.5 inches, or from 2 inches to 3 inches, or is 2.5 inches; or from 2.5 to 15 inches.

According to some embodiments, the width W of the body member 200 is constant along the length L of the body member 200. According to yet other embodiments, the width W varies between the hand engagement end 204 and the tool end 205. In some embodiments, the hand engagement end 204 is wider than the tool end 205. A representative example of such an embodiment is shown in FIG. 2(a), wherein width W of the body member 200 gradually and continuously tapers from a greater width at the hand engagement end 204, to a lesser width at the tool end 205. In other embodiments, the hand engagement end 204 is narrower than the tool end 205. A representative example of such an embodiment is shown in FIG. 2(b), wherein width W of the body member 200 gradually and continuously broadens from a lesser width at the hand engagement end 204, to a greater width at the tool end 205. In yet other embodiments, the widths of the hand engagement end 204 and the tool end 205 vary, but the change in width along the length L of the body member 200 is not continuous or gradual; a representative example of such an embodiment is depicted in FIG. 2(c).

Hand-held tool implements 100 according to the instant invention comprise on the body member 200 a tool end 205. According to one or more of the various embodiments, the tool end 205, either alone, or together with one or more of the back face 202 and one or both of the first and second side edges 203, are maneuvered by the user's hand to carry out such tasks as cutting, digging, scraping, scooping and spreading, and the like. Accordingly, the body member 200 of hand-held tool implement 100 comprises a means for executing tasks such as scraping, digging, scooping, spreading, and the like, wherein the means is situated at or adjacent to the tool end 205.

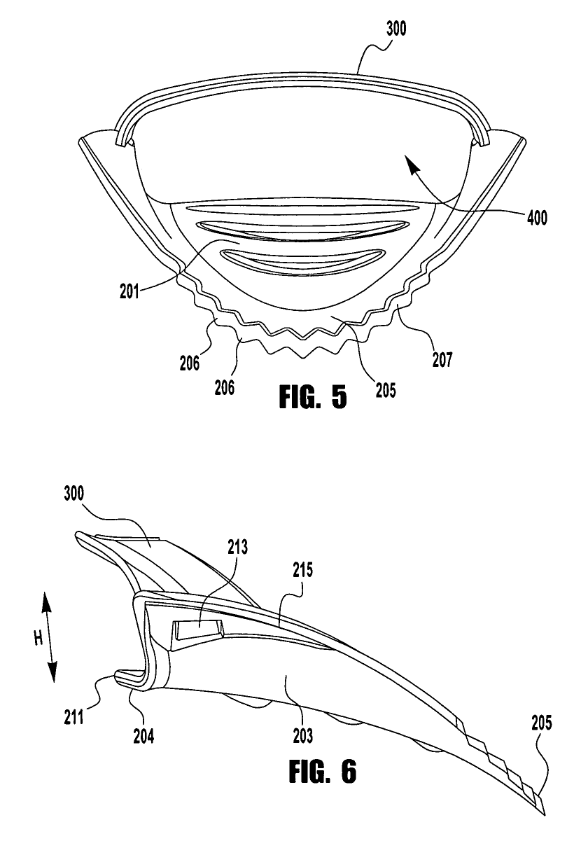

In some embodiments, the hand-held tool implement 100 comprises a cutting edge. A representative example of such an embodiment is shown in FIG. 2(a) and FIG. 5. The depicted body member 200 comprises a tool end 205 that comprises a series of teeth 206 of approximately equal size and shape. The teeth 206 have a beveled leading edge 207 situated on the top face 201 of the body member 200. Of course in alternate embodiments (not shown) teeth 206 may be irregular in one or more properties of spacing, height, thickness, size and shape. Likewise, in alternate embodiments, such as depicted in FIG. 2(c), teeth may have no bevel, or may in yet other embodiments be beveled on both the top face 201 and the bottom face 202, or only on the bottom face 202. Further as shown in the depicted embodiment of FIG. 2(a), the tool end 205 has a rounded shape with a radius of curvature and likewise has a curvature that is along both the width W and the length L of the body member 200. In yet other embodiments, a representative example of which is shown in FIG. 2(c), the tool end 205 comprises teeth 206 arranged in a substantially straight orientation across the tool end 205, wherein the shape of the tool end 206 is substantially flat, having no significant curvature along either the length L or width W dimensions of the body member 200.

Referring now to FIG. 2(b), the depicted body member 200 comprises a tool end 205 that comprises a straight edge 212. The edge 212 is not beveled. Of course in alternate embodiments (not shown) the edge may have a bevel on one or both the top face 201 and the bottom face 202. Further as shown in the depicted embodiment, the tool end 205 has a curvature along both the width W and length L dimensions of the body member 200. Of course it should be understood that various combinations of shape features of the tool end 205 are encompassed in alternate embodiments according to the instant invention, including embodiments that combine one or more of the features of flatness and curvature along one or both of the length L and width W dimensions, and the features of straight, curved or pointed shapes along the tool end 205. Referring now to FIG. 2(d), the depicted body member 200 comprises a tool end 205 that comprises a bowl or scoop shaped portion 210 wherein the bowl 210 is formed on the front face 201 of the body member 200. Of course in alternate embodiments (not shown) the shaped portion, such as a bowl or other shape, may be on the bottom face 202; such features may or may not have a bevel on one or both the top face 201 and the bottom face 202.

Turning now to FIG. 4, various embodiments of a retaining strap 300 are depicted. The retaining straps 300 of the instant invention are engageable with a body member 200, wherein a retaining strap 300, when engaged with a body member 200, traverses the top face 201 of the body member 200 to form an aperture 400, whereby, when one or more fingers of a human hand is inserted therethrough, the volar surface (the palm side of the hand) of the one or more fingers is in contact with the top face 201 of the body member 200, and the dorsal surface (the top side of the hand) of the one or more fingers (including the adjacent portions of the user's hand) is in contact with the strap member 300. Retaining straps 300 are fixed or adjustable. Adjustable retaining strips 300 can be adjusted in a width W′ dimensions to adjust the size of the aperture 400 formed by an engaged retaining strip 300 and body member 200.

According to some embodiments, the retaining strap has a length L′ that is only a fraction of the length L of the body member 200, whereby, when one or more fingers of a human hand is inserted through the aperture 400 formed by the engaged body member 200 and retaining strap 300, the distal portions of the inserted one or more fingers are exposed. A representative example of such an embodiment is shown in FIG. 4(a), and in FIG. 2(a). According to yet other embodiments, the retaining strap 300 has a length L′ that is a greater portion of or in some embodiments equivalent to the length L of the body member 200, whereby, when one or more fingers of a human hand is inserted through the aperture 400 formed by the engaged body member 200 and retaining strap 300, the inserted portions of the one or more fingers are at least partially, or completely enclosed therebetween. A representative example of such an embodiment is shown in FIG. 4(b) and in FIG. 2(c).

According to the instant invention, a retaining strap 300 is engaged with a body member 200 by clip, screw, hook, snap-fit, glue, hinge, ultrasonic weld, heat bonding, rivet, or weld means, or other engagement means. FIG. 2(a) (2) and FIG. 3, for example, show snap-fit engagement 213 between a retaining strap 300 and a body member 200, wherein such engagement is via connections on the first and second sides edges 203 of the body member 200, and wherein the retaining strap 300 is substantially aligned with the hand engagement end 204 of the body member 200.

In some embodiments, the retaining strap 300 is releasably engaged with the body member by either one or two connection points. According to particular embodiments thereof, releasable engagement is with at least one of the first and second side edges 203 of the body member 200. In other embodiments, the retaining strap 300 is permanently engaged with the body member 200. According to particular embodiments thereof, the retaining strap 300 is integral with the body member 200. Engagement between the retaining strap 300 and the body member may be at one or more connection points along one or both sides of the retaining strap 300 and the body member 200.

The body members 200 provided herein comprise material that is substantially non-elastic, generally retains its shape, and is semi-flexible, semi-rigid or rigid. Examples of material from which body members 200 are formed include metal, wood, paper, or plastic, or composites comprising one or more thereof. In some embodiments, the body members are formed of plastic, such as for example molded plastic. Plastic materials may comprise materials such as rubber to confer flexibility. The retaining straps 300 provided herein comprise material that is elastic or inelastic, and that generally retains its shape. The materials may are generally semi-flexible, semi-rigid or rigid. Examples of material from which retaining strips 300 are formed include metal, wood, paper, or plastic, elastomers such as natural or synthetic rubber and like materials, or composites comprising one or more thereof. In some embodiments, the body members are formed of plastic, such as for example molded plastic. Plastic materials may comprise materials such as rubber to confer flexibility. According to some embodiments, the body members 200 and the retaining straps 300 of the hand-held tool implements 100 are each formed from the same material. According to particular embodiments thereof, the materials comprise molded plastic.

Hand-held tool implements 100 according to the instant invention comprise in some embodiments a glove member 500. Glove members 500 are insertable through the aperture 400 formed by an engaged body member 200 and a retaining strap 300. According to some embodiments, a glove member is free from a body member 200 and a retaining strap 300. According to alternate embodiments, a glove member is attached to one or both of a body member 200 or a retaining strap 300, and is in some particular embodiments integral one or both of a body member 200 or a retaining strap 300. Glove members 500 comprise one or more openings for receiving at least one or more phalange segments of one or more fingers of a human hand. According to some embodiments, glove members 500 comprise openings for receiving substantially all of a human hand. According to yet other embodiments, glove members 500 comprise openings for receiving all fingers of a human hand. Of course it should be understood that glove members 500 according to the instant invention are sized in ranges to accommodate a variety of sizes of adult and juvenile human hands, or are otherwise capable of accommodating and fitting such a range of hand sizes.

Glove members 500 are formed from a variety of materials. According to certain embodiments, particularly those wherein a glove member 500 is integral with a body member 200 or retaining strap 200, the glove member 500 comprise the same material as that of the body member 200 or the retaining strap 300. According to some embodiments, the glove member 500 is formed from the same material as the body member 200 and is integrated therewith. In alternate embodiments, glove members 500 are formed with material that is substantially flexible and generally conforms to the shape of at least a portion of at least one or more fingers of a human hand. Examples of such materials include, but are not limited to cotton, plastic, rubber, or like material. Materials for fabricating gloves are well known in the relevant art.

The hand-held tool implements 100 of the instant invention can be employed for a wide variety of uses. According the embodiment of the tool implement 100 selected by the user, appropriately sized body member 200 and retaining strap 300 are selected based on the user's hand size, or on the intended use. For example, size selection may be appropriate to allow for comfortable accommodation of a child's hand verses an adult's hand, or for a large adult's hand verses a small adult's hand. Alternatively, size selection may be appropriate to accommodate the desired use of the device, wherein the desired use may necessitate the use of one, two, three, or more fingers of a user, or of all or only a portion of the users hand. According to embodiments of the tool implement 100 comprising a glove member 500, the appropriate size and material of glove may be selected by the user. A particular hand-held tool implement 100 will be selected by a user based on the target material or substrate to be manipulated.

Generally, the hand-held tool implements 100 are donned by a user by insertion of one or more fingers of a user through the aperture formed by an engaged body member 200 and retaining strap 300. According to embodiments of the tool implement 100 comprising a glove member 500, the user must don the glove member 500 either prior to, or contemporaneous with donning the engaged body member 200 and retaining strap 300. In some embodiments, the body member 200 and retaining strap 300 must first be assembled by the user prior to use.

Hand-held tool implements 100 are used for tasks such as cutting, digging, scraping, scooping and spreading. Referring to FIG. 1 and FIG. 6, for example, the depicted tool implement 100 is useful for activities involving digging and scraping. For example, the tool implement 100 can be used for scraping and removing the flesh from fruits and vegetables, such as pumpkins and similar vegetables and replicas thereof. Referring to FIG. 2(c), the depicted tool implement 100 could be used for scraping or scaling fish, or other such activity wherein a relatively straight edge with teeth or the like are useful. Referring to FIG. 2(b), the depicted tool implement 100 could be used for scooping, digging, scraping, and spreading attendant to performance of cleaning tasks, crafts, baking and cooking, light construction and remodeling, and other like activities. An example of such an activity would be scraping paint or other material for removal from a surface such as a wall. The implement could likewise be used for applying plaster, joint compound or other light construction material to a target surface. Alternatively, the implement could be used for an aid in baking and cooking applications, such as spreading and manipulating dough, frosting cakes, and the like. The multipurpose hand-held tool implements are also useful for scooping, digging, spreading, or otherwise manipulating earth, clay, soil, dirt, vermiculite, humus, and other like materials in connection with lawn and gardening activities. The implements depicted in FIG. 2(a), and in FIG. 2(d) are examples of embodiments that would be suitable for such application. Of course many variations to the embodiments of hand-held tool implements described herein or otherwise encompassed within the scope of the claims are possible, and the uses described herein are merely examples of the possible uses for such tool implements.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

While particular embodiments of the subject invention have been described, it will be obvious to those skilled in the art that various changes and modifications of the subject invention can be made without departing from the spirit and scope of the invention. In addition, while the present invention has been described in connection with certain specific embodiments thereof, it is to be understood that this is by way of illustration and not by way of limitation and the scope of the invention is defined by the appended claims which should be construed as broadly as the prior art will permit.

What is claimed is:

1. A hand-held tool implement, comprising:
a body member comprising: a top face; a bottom face; first and second side edges; a hand engagement end; a tool end; a length bounded by the hand engagement end and the tool end, the length sufficient to accommodate contact with at least a portion of one or more fingers of a human hand; and, a width bounded by the first and second side edges; and
a retaining strap engageable with the body member, wherein the retaining strap, when engaged with the body member, traverses the top face of the body member to form an aperture, whereby, when one or more fingers of a human hand is inserted therethrough, the volar surface of the one or more fingers is in contact with the top face of the body member, and the dorsal surface of the one or more fingers is in contact with the retaining strap.

2. A hand-held tool implement according to claim 1, wherein the body member is substantially rigid.

3. A hand-held tool implement according to claim 1, wherein the body member is substantially semi-rigid.

4. A hand-held tool implement according to claim 1, wherein the body member is substantially flexible.

5. A hand-held tool implement according to claim 1, wherein the length is sufficient to accommodate contact with at least a portion of one or more fingers of an adult human hand.

6. A hand-held tool implement according to claim 1, wherein the length is sufficient to accommodate contact with at least a portion of one or more fingers of a juvenile human hand.

7. A hand-held tool implement according to claim 1, wherein the length is sufficient to accommodate contact with at least a portion of, but nor more than, the phalange segments of one or more fingers of a human hand.

8. A hand-held tool implement according to claim 7, wherein the length is sufficient to accommodate contact with at least a portion of, but nor more than, the phalange segments of one or more fingers of an adult human hand.

9. A hand-held tool implement according to claim 7, wherein the length is sufficient to accommodate contact with at least a portion of, but nor more than, the phalange segments of one or more fingers of a juvenile human hand.

10. A hand-held tool implement according to claim 1, wherein the length is from 0.5 inches to 5 inches.

11. A hand-held tool implement according to claim 10, wherein the length is from 1 inch to 3.5 inches.

12. A hand-held tool implement according to claim 1, wherein the tool end of the body member comprises a means for scraping or digging.

13. A hand-held tool implement according to claim 1, wherein the tool end of the body member comprises a cutting edge.

14. A hand-held tool implement according to claim 13, wherein the cutting edge comprises teeth.

15. A hand-held tool implement according to claim 13, wherein the cutting edge is beveled on one or both of the front and bottom faces of the body member.

16. A hand-held tool implement according to claim 15, wherein the cutting edge is beveled only on the top face of the body member.

17. A hand-held tool implement according to claim 1, wherein the tool end is curved.

18. A hand-held tool implement according to claim 1, wherein the tool end is pointed.

19. A hand-held tool implement according to claim 1, wherein the tool end is straight.

20. A hand-held tool implement according to claim 1, wherein the body member is substantially planar and comprises a central portion located between the first and second side edges and the hand engagement and tool ends.

21. A hand-held tool implement according to claim 20, wherein the body member has a curvature along its length such that when the body member is resting on its bottom face on a flat surface, the hand engagement and tool ends are in contact with the flat surface, and at least a portion of the central portion is not in contact with the flat surface.

22. A hand-held tool implement according to claim 20, wherein the central portion comprises a gripping means.

23. A hand-held tool implement according to claim 22, wherein the gripping means comprises one or more ridges, baffles, grooves, or like structural features.

24. A hand-held tool implement according to claim 22, wherein the gripping means comprises surface texture that increases friction between the body member and the one or more fingers of a human hand in contact therewith.

25. A hand-held tool implement according to claim 1; wherein the width of the body member is greater at the hand engagement than at the tool end.

26. A hand-held tool implement according to claim 1; wherein the width of the body member tapers continuously from the hand engagement end to the tool end.

27. A hand-held tool implement according to claim 1; wherein the width of the body member tapers discontinuously from the hand engagement end to the tool end.

28. A hand-held tool implement according to claim 1; wherein the width of the hand engagement end is sufficient to accommodate contact with one or more fingers of a human hand.

29. A hand-held tool implement according to claim 28; wherein the width of the hand engagement end is sufficient to accommodate contact with one or more fingers of an adult human hand.

30. A hand-held tool implement according to claim 28; wherein the width of the hand engagement end is sufficient to accommodate contact with one or more fingers of a juvenile human hand.

31. A hand-held tool implement according to claim 1; wherein the width of the hand engagement end is from 0.5 inches to 4.5 inches.

32. A hand-held tool implement according to claim 31; wherein the width of the hand engagement end is from 1.5 inches to 3.5 inches.

33. A hand-held tool implement according to claim 32; wherein the width of the hand engagement end is from 2 inches to 3 inches.

34. A hand-held tool implement according to claim 1; wherein the first and second side edges have a height that extends above the top face of the body member and have an orientation that is oblique relative to the top face of the body member.

35. A hand-held tool implement according to claim 34, wherein the height of the first and second side edges decreases along the length of the body member from a maximum height at the hand engagement end.

36. A hand-held tool implement according to claim 35, wherein the height of the first and second side edges decreases to a substantially nil height at a point before the tool end of the body member.

37. A hand-held tool implement according to claim 35, wherein the height of the first and second side edges decreases to a substantially nil height at a point at the tool end of the body member.

38. A hand-held tool implement according to claim 1, wherein the retaining strap has a length that is equivalent to the length of the body member, whereby, when one or more fingers of a human hand is inserted in the aperture, the inserted portions of the one or more fingers are enclosed therebetween.

39. A hand-held tool implement according to claim 1, wherein the retaining strap has a length that is only a fraction of the length of the body member, whereby, when one or more fingers of a human hand is inserted therethrough, the distal portions of the inserted one or more fingers are exposed.

40. A hand-held tool implement according to claim 1, wherein the retaining strap is engaged with the body member by clip, screw, hook, snap-fit, glue, hinge, ultrasonic weld, heat bonding, rivet, or weld means, or other engagement means.

41. A hand-held tool implement according to claim 1, wherein the retaining strap is releasably engaged with the body member.

42. A hand-held tool implement according to claim 41, wherein the releasable engagement is with at least one of the first and second side edges of the body member.

43. A hand-held tool implement according to claim 1, wherein the retaining strap is permanently engaged with the body member.

44. A hand-held tool implement according to claim 43, wherein the retaining strap is integral with the body member.

45. A hand-held tool implement according to claim 1, wherein the retaining strap is engaged with the body member at or near the hand engagement end of the body member.

46. A hand-held tool implement according to claim 1, wherein the body member is formed from metal, wood, paper, or plastic, or composites comprising one or more thereof, and wherein the retaining strap is formed from metal, wood, paper, or plastic, composites comprising one or more thereof, or rubber or like material.

47. A hand-held tool implement according to claim 46, wherein the body member and the retaining strap are each formed from molded plastic.

48. A hand-held tool implement comprising:
a body member comprising: a top face; a bottom face; first and second side edges; a hand engagement end; a tool end; a length bounded by the hand engagement end and the tool end, the length sufficient to accommodate contact with at least a portion of one or more fingers of a human hand; and, a width bounded by the first and second side edges;
a retaining strap engageable with the body member, wherein the retaining strap, when engaged with the body member, traverses the top face of the body member to form an aperture, whereby, when one or more fingers of a human hand is inserted therethrough, the volar surface of the one or more fingers is in contact with the top face of the body member, and the dorsal surface of the one or more fingers is in contact with the strap member; and
a glove member insertable through the aperture formed by the engaged body member and retaining strap.

49. A hand-held tool implement according to claim 48, wherein the glove member is attached to the body member or the retaining strap.

50. A hand-held tool implement according to claim 48, wherein the glove member is integral with the body member.

51. A hand-held tool implement according to claim 48, wherein the glove member is integral with the retaining strap.

52. A hand-held tool implement according to claim 48, wherein the glove member comprises openings for receiving at least one or more phalange segments of at least one or more fingers of a human hand.

53. A hand-held tool implement according to claim 48, wherein the glove member comprises openings for receiving substantially all of a human hand.

54. A hand-held tool implement according to claim 50, wherein the glove member and the body member are formed with the same material.

55. A hand-held tool implement according to claim 51, wherein the glove member and the retaining strap are formed with the same material.

56. A hand-held tool implement according to claim 48, wherein the glove member is formed with material that is substantially flexible and generally conforms to the shape of at least a portion of at least one or more fingers of a human hand.

57. A hand-held tool implement according to claim 56, wherein the glove material is cotton, plastic, rubber, or like material.

58. A hand-held tool implement, comprising:
a body member comprising: a top face; a bottom face; first and second side edges; a hand engagement end; a tool end; a length bounded by the hand engagement end and the tool end, the length sufficient to accommodate contact with at least a portion of one or more fingers of a human hand; and, a width bounded by the first and second side edges; and
a retaining strap engageable with the body member; and
an aperture formed between the body member and the retaining strap.
